(19) United States
(12) Patent Application Publication
(10) Pub. No.: US 2014/0029930 A1
(43) Pub. Date: Jan. 30, 2014

(54) DEVICE FOR EXTENDING AND CONTROLLING SIGNALS OF A CAMERA SHUTTER RELEASE CABLE THROUGH ISOLATED SWITCHES

(71) Applicants: Peng-Cheng Lai, Los Altos, CA (US); Chih-Chuan Kao, New Taipei City (TW)

(72) Inventors: Peng-Cheng Lai, Los Altos, CA (US); Chih-Chuan Kao, New Taipei City (TW)

(21) Appl. No.: 13/560,671

(22) Filed: Jul. 27, 2012

(51) Int. Cl. G03B 17/38

(52) U.S. Cl. 396/263

(57) ABSTRACT

A device for extending and controlling signals of a camera shutter release cable through an isolated switch is provided. A single short signal is generated to a camera shutter release cable by a manual button, another control device or a computer command, and extended into a multiple short signal with well isolation, good stability and enough voltage level through multiple isolated switches, so as to simultaneously activate several cameras connected in parallel to focus and snap. Therefore, it is able to prevent that the voltage levels provided by a single short signal are too low to simultaneously activate all of those cameras connected from the interference between them. Moreover, the foregoing multiple short signal can further be individually, partially or together controlled by a computer, a USB and a CPU, so as to simultaneously activate the cameras connected in parallel to focus and snap rapidly.

### FIELD OF THE INVENTION

The present invention generally relates to a device capable of extending a single short signal of a camera shutter release cable into a multiple short signal with well isolation, good stability and enough voltage level through a plurality of isolated switches, such as relays or photocoupler, so as to simultaneously activate a plurality of cameras connected in parallel to focus and snap, and more particularly to a device capable of individually, partially or together controlling the extended multiple short signal and the connected cameras by a computer, a universal serial bus (USB hereinafter) cable and a central processing unit (CPU hereinafter), so as to simultaneously activate the cameras connected in parallel to focus and snap rapidly. In addition, the device of the present invention can control more cameras by connecting a plurality of control boards in parallel.

### DESCRIPTION OF THE RELATED ART

In the related art, a computer 1 usually controls a single camera 3 to focus and snap by a USB cable 2 as illustrated in FIG. 1. In contrast, in order to control a plurality of cameras to focus and snap, the computer 4 is usually connected with a USB hub 6 through a USB cable 5 first, and then further connected with a plurality of cameras 11, 12, 13, 14 through a plurality of USB cables 7, 8, 9, 10, in parallel as illustrated in FIG. 2, so as to respectively control each of the cameras in sequence through identifications (ID hereinafter) for representing different cameras and software developer's kits (SDK) provided by camera manufacturers. However, the control manner as illustrated in FIG. 2 is unable to simultaneously activate the plurality of cameras connected with each other to rapidly focus and snap.

Another approach for controlling a single camera 17 to focus and snap as illustrated in FIG. 3 is practiced by using a camera shutter release cable 16. In this approach, the user can directly control the camera 17 to focus and snap by pressing down a manual button 15. As illustrated in FIG. 4, a contact A is a common point of the manual button 15, so that it is able to focus as long as the user lightly presses down the manual button to short out the contacts A and B within the manual button, and it is able to snap as long as the user continuously presses down the manual button to short out all of the contacts A, B and C.

### SUMMARY OF THE INVENTION

The present invention is directed to simultaneously controlling a plurality of cameras to rapidly snap by a single short signal provided through a camera shutter release cable, so as to significantly decrease the required time for creating and composing a spherical 3D image and facilitate the spherical 3D image applications can be widely used in commerce, wherein the foregoing single short signal is generated by a manual button, another control device or a computer command.

The present invention is also directed to extending a single short signal into a multiple short signal with well isolation, good stability and enough voltage level, so as to control a plurality of cameras to focus and snap simultaneously. In addition, the present invention can individually, partially or together control the multiple short signal and the cameras connected therewith as well.

The present invention provides a device capable of extending a single short signal of a camera shutter release cable into a multiple short signal with well isolation, good stability and enough voltage level through a plurality of isolated switches, so as to simultaneously control a plurality of cameras connected with each other in parallel. Alternatively, the present invention provides a device capable of individually, partially or together control the extended multiple short signal and the cameras connected therewith through a computer, a USB cable and a CPU. In contrast, as illustrated in FIG. 5, if a user desires to directly use a manual button 18 to directly control a plurality of cameras 24, 25, 26, 27, 28 connected with each other in parallel through a plurality of camera shutter release cables 19, 20, 21, 22, 23 without using any relay or photocoupler, for example but not limited to a metal oxide semiconductor relay (MOS relay), to isolate the signals, some or most of the cameras may not be activated or even damaged, because an impedance issue resulted from an interference between the signals. For example, as long as voltage levels of the cameras are decreased to lower than 0.7 V when the user presses down the manual button to short out the camera shutter release cable, the cameras will be activated to focus or snap. However, some of the cameras may not be activated to focus or snap if the voltage levels thereof are not decreased to lower than 0.7 V because the signals are interfered to each other. Herein, the short signal of the camera shutter release cable can be generated by not only the manual button, but also another control device or a computer command.

### BRIEF DESCRIPTION OF THE DRAWINGS

FIG. 1 illustrates an approach of the related art, wherein a computer is directly used to control a single camera through a USB cable.

FIG. 2 illustrates an approach of the related art, wherein a computer is directly used to control a plurality of cameras through a plurality of USB cables and a USB hub.

FIG. 3 illustrates another approach of the related art, wherein a manual button and a camera shutter release cable are directly used to control a camera to snap.

FIG. 4 illustrates short points in a manual button for focusing and snapping according to the related art.

FIG. 5 illustrates a derivation application of the manual button in the related art for controlling a plurality of cameras.

FIG. 6 illustrates an example of extending a single short signal of a camera shutter release cable into a multiple short signal to control a plurality of cameras to focus and snap simultaneously according to an embodiment of the present invention.

FIG. 7 illustrates an example of extending a single short signal of a camera shutter release cable or a computer command into a multiple short signal to control a plurality of cameras to focus and snap simultaneously according to another embodiment of the present invention.

FIG. 8 illustrates an example of extending a single short signal of a camera shutter release cable into a multiple short signal to control a plurality of cameras to focus and snap simultaneously through a plurality of control boards connected in parallel according to an embodiment of the present invention.

FIG. 9 illustrates an example of extending a computer command into a multiple short signal to control a plurality of cameras to focus and snap through a plurality of control boards connected in parallel according to another embodiment of the present invention.

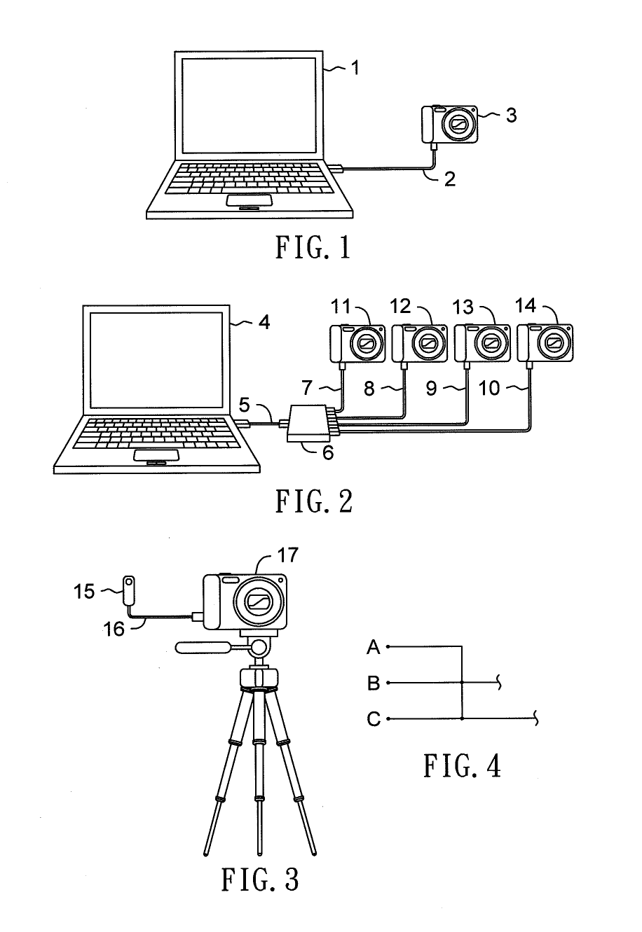

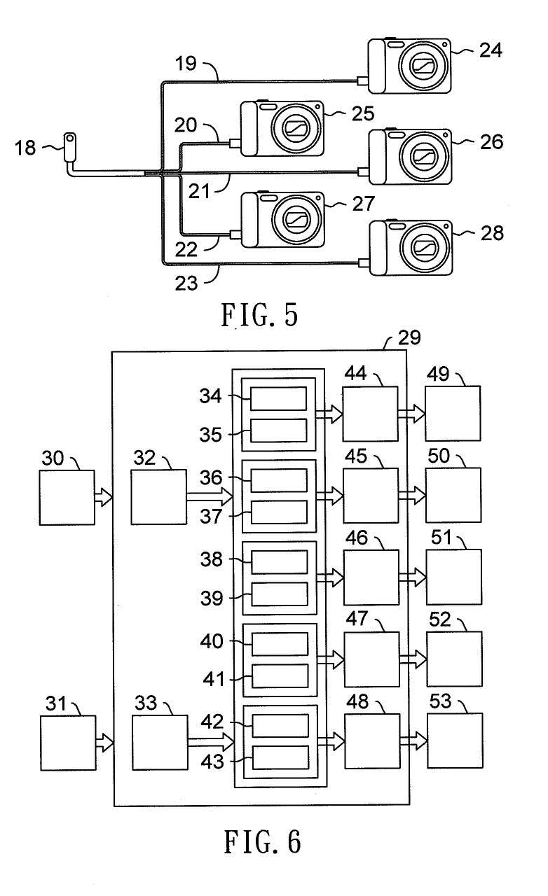

### DETAILED DESCRIPTION OF THE INVENTION

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations are not described in detail in order not to obscure the present invention.

FIG. 6 illustrates an example of extending a single short signal of a camera shutter release cable into a multiple short signal to control a plurality of cameras to focus and snap simultaneously according to an embodiment of the present invention. A power source 30 supplies electricity to a control board 29 (or another control device), and the electricity is transformed into 5V direct current (DC hereinafter) input 32 by the control board 29 and then supplied to a plurality of isolated switches 34, 36, 38, 40, 42 (for focusing) and a plurality of isolated switches 35, 37, 39, 41, 43 (for snapping). A single short signal 31 generated by a manual button, another control device or a computer command can be transmitted to and activate the isolated switches 34˜43 through a shutter release jack 33 (for focusing and snapping), so as to be extended into a multiple short signal with well isolation, good stability and enough voltage level. Then, the multiple short signal are respectively transmitted to a plurality of cameras 49, 50, 51, 52, 53 connected in parallel through a plurality of shutter release jacks 44, 45, 46, 47, 48, so as to simultaneously activate the cameras 49, 50, 51, 52, 53 to focus or snap. Herein, each one of the isolated switches can be practiced by a relay or a photocoupler.

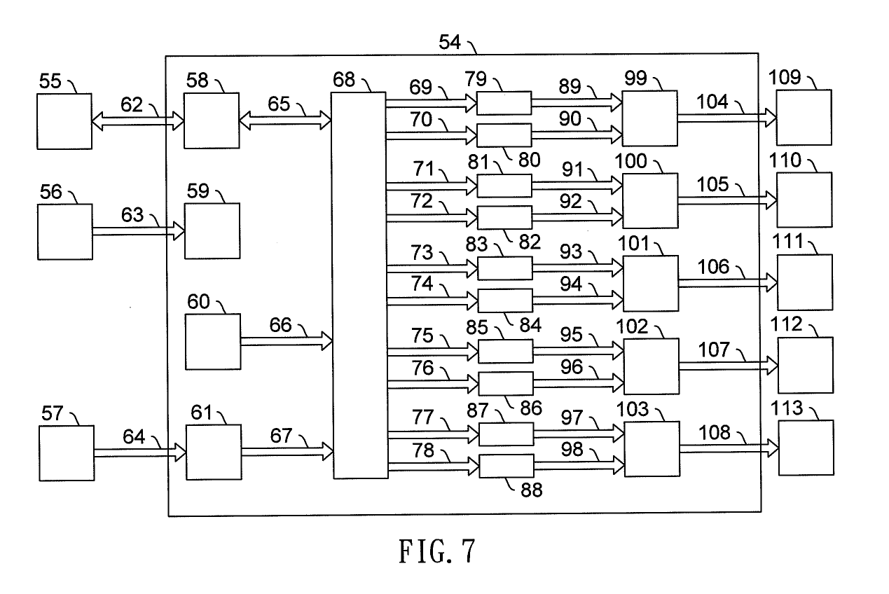

FIG. 7 illustrates an example of extending a single short signal of a camera shutter release cable or a computer command into a multiple short signal to control a plurality of cameras to focus and snap simultaneously according to another embodiment of the present invention. A power source 56 supplies electricity to a control board 54 (or another control device), and the electricity is transformed into 5V DC input 59 by a power cord 63 and then supplied to all components in the control board 54. A single short signal 57 generated by a manual button or another control device can be transmitted to and activate the isolated switches 79˜88 through a signal cable 64, a shutter release jack 61 (for focusing and snapping) and a signal cable 67 in sequence, so as to be extended into a multiple short signal with well isolation, good stability and enough voltage level. Then, the multiple short signal are respectively transmitted to a plurality of cameras 109˜113 connected in parallel through a plurality of signal cables 89˜98, a plurality of shutter release jacks 99˜103 and a plurality of signal cables 104˜108 in sequence, so as to simultaneously activate the cameras 109˜113 to focus or snap, and the description up to here in the present embodiment is similar to what disclosed in FIG. 6. Alternatively, a computer command provided by a computer 55 can be transmitted to a CPU 68 for control through a USB cables 62, a USB integrated circuit (IC hereinafter) 58 and a signal cable 65 in sequence, and then the CPU 68 transforms the computer command into at least one control signal. Then, the control signal is transmitted to and activate specific at least one of isolated switches 79˜88 (for focusing and snapping) through specific at least one of output ports of the CPU and specific at least one of signal cables 69˜78 in sequence, so as to form a single or a multiple short signal. Afterward, the single or the multiple short signal are respectively transmitted to specific at least one of the cameras 109˜113 through specific at least one of the signal cables 89˜98, specific at least one of the shutter release jacks 99˜103 and specific at least one of the signal cables 104˜108 in sequence, so as to individually, partially or together activate the cameras 109˜113 connected in parallel to focus or snap. Herein, the computer described above can further be a controller with a CPU, and the USB IC 58 can further be any other type of control IC, such as an IEEE 1394 control IC or a RS232 control IC.

In another word, when the single short signal 57 generated by the manual button or another control device is inputted, the operation result is similar to what disclosed in FIG. 6, i.e. the cameras 109˜113 are simultaneously activated to focus and snap, but the computer 55 is unable to be operated at the time. In contrast, when the computer command generated by the computer 55 is inputted, the manual button or another control device does not generate the single short signal 57 as well. In the other word, it should be selected between the computer command generated by the computer 55 and the single short signal 57 generated by the manual button or another control device. Furthermore, an ID control unit 60 connected with the CPU 68 through a signal cable 66 can be used for assisting the computer 55 in indentifying the control boards only if a plurality of control boards 54 are connected in parallel. The ID control unit herein can be a dip switch or a memory IC. In a nutshell, when the single short signal 57 generated by the manual button or another control device is inputted (the computer is unable to be operated now), the single short signal 57 is extended into the multiple short signal through the isolated switches 79˜88 for simultaneously activating the cameras 109˜113 to focus and snap. In contrast, when the computer command generated by the computer 55 is inputted (the manual button and another control device are unable to be operated now), the CPU 68 differentiates which of the isolated switches 79˜88 should be activated based on the computer command and then transforms the computer command into at least a control signal, so as to individually, partially or together control the cameras 109˜113.

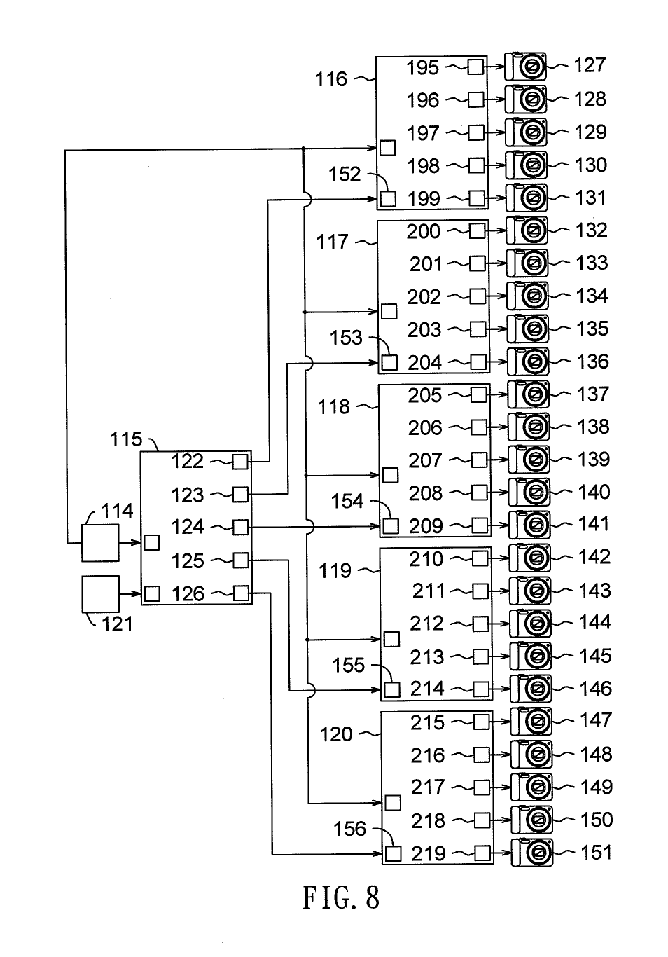

FIG. 8 illustrates an example of extending a single short signal of a camera shutter release cable into a multiple short signal to control a plurality of cameras to focus and snap simultaneously through a plurality of control boards connected in parallel according to an embodiment of the present invention. In a word, FIG. 8 illustrates a device connecting a plurality of control boards the same as the control board 29 illustrated in FIG. 6 in parallel, so as to connect more cameras with the device and then simultaneously activate the cameras to focus and snap. A plurality of output shutter release jacks 122˜126 of a control board 115 respectively connect with a plurality of input shutter release jacks 152˜156 of a control board 116˜120, and a power source 114 supplies electricity to the control boards 115˜120. When the single short signal 121 is inputted, the multiple short signal extended to the output shutter release jacks 122˜126 are further extended into a plurality of multiple short signals to the output shutter release jacks 195˜219 of the control boards 116˜120, so as to simultaneously activate the cameras 127˜151 connected with the output shutter release jacks 195˜219 to focus or snap. In another word, when the single short signal 121 is inputted, all of the cameras 127˜151 are activated simultaneously.

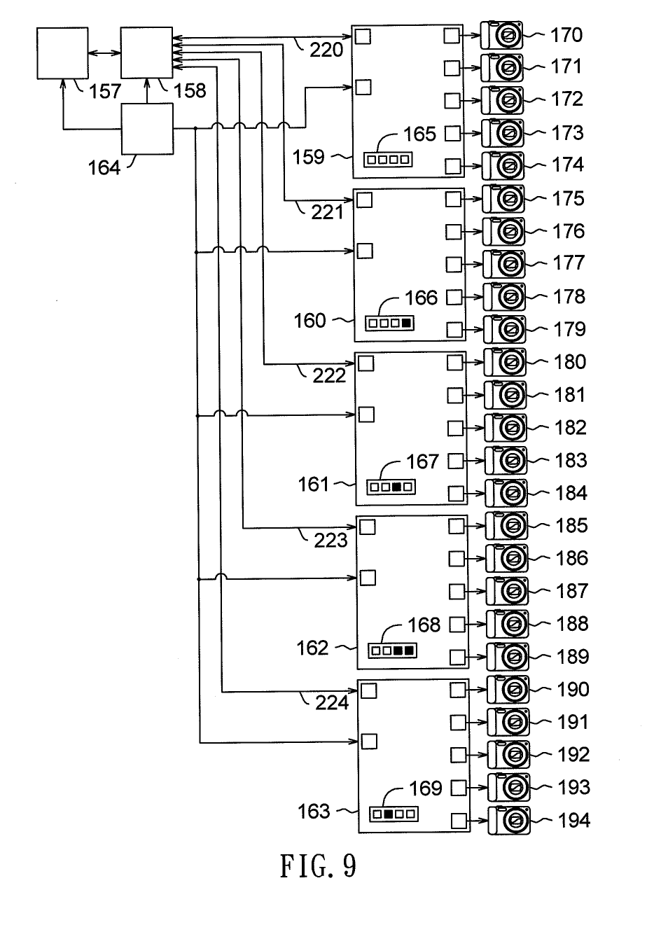

FIG. 9 illustrates an example of extending a computer command into a multiple short signal to control a plurality of cameras to focus and snap through a plurality of control boards connected in parallel according to another embodiment of the present invention. In a word, a plurality of control boards 159˜163 are the same as the control board 54 illustrated in FIG. 7, a computer 157 connects with the control boards 159˜163 in parallel through USB cables 220˜224 directly or with a USB hub 158, and a power source 164 supplies electricity to the computer 157, the USB hub 158 and the control boards 159˜163. An ID code of an ID control unit 165 in the control board 159 is 0000, an ID code of an ID control unit 166 in the control board 160 is 0001, an ID code of an ID control unit 167 in the control board 161 is 0010, an ID code of an ID control unit 168 in the control board 162 is 0011, and an ID code of an ID control unit 169 in the control board 163 is 0100. When the computer 157 provides a computer command, the computer command is transmitted to the control boards 159˜163 through the USB hub 158, wherein the computer 157 connects with the control boards 159˜163 in parallel through the USB cables 220˜224 directly or with the USB hub 158 in parallel. Next, the computer 157 selects and provides the computer command to at least one of the control boards 159˜163 according to the ID codes 0000, 0001, 0010, 0011 and 0100 in the ID control units 165˜169, so as to enable the CPU(s) in the selected at least one of the control boards 159˜163 to transform the computer command into at least a control signal for activating at least one of isolated switches in the selected at least one of the control boards 159˜163 and thus forming a single or a multiple short signal. Thereafter, the single or the multiple short signal is outputted through at least one of output shutter release jacks in the selected at least one of the control boards 159˜163, so as to individually, partially or together activate the cameras 170˜194 connected in parallel with the selected at least one of the control boards 159˜163. In another word, the control boards are selected according to the different ID codes thereof. For example, if the ID code 0000 in the ID control unit 165 is selected, the computer 157 controls the CPU in the control board 159 to transform the single computer command provided by the computer into a multiple short signal, and the multiple short signal is transmitted to the output shutter release jacks on the control board 159, so as to control the cameras 170˜174 connected in parallel with the control board 159. Similarly, the ID codes 0001, 0010, 0011 and 0100 can be respectively used for controlling the control boards 160˜163 and the cameras connected in parallel with the control boards 160˜163, so as to individually, partially or together control the cameras 170˜194 connected with the selected control boards 159˜163. In the above-mentioned embodiment, the computer 157 connects with the control boards 159˜163 through the USB hub 158. However, in the other embodiments, the computer 157 can directly connect with the control boards 159˜163 through the USB cables 220˜224 as well.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A device for extending signals of a camera shutter release cable through isolated switches, comprising:
a first control board and a plurality of second control boards the same as the first control board, respectively comprising:
an input shutter release jack;
a plurality of output shutter release jacks, wherein the second control boards are connected in parallel with the first control board through the output shutter release jacks;
a plurality of isolated switches, connected between the input shutter release jack and the output shutter release jacks; and
a DC input, supplying electricity to the isolated switches;
a power source, providing the DC input to the first control board and each one of the second control boards; and
a single short signal, inputted to the first control board and activating the isolated switches of the first control board through the input shutter release jack of the first control board, so as to be extended into multiple short signals, and the multiple short signals outputted through the output shutter release jacks of the first control board are further extended into a plurality of the multiple short signals through the isolated switches of the second control boards, so as to simultaneously activate all of the cameras connected in parallel with the output shutter release jacks of the second control boards.

2. The device for extending signals of a camera shutter release cable through isolated switches as claimed in claim Error! Reference source not found., wherein the isolated switches are relays or photocouplers.

3. The device for extending signals of a camera shutter release cable through isolated switches as claimed in claim Error! Reference source not found., wherein the single short signal is generated by a manual button, a control device or a computer.

4. (canceled)

5. A device for extending signals of a camera shutter release cable through isolated switches, comprising:
a control board, comprising:
a CPU;
a plurality of output shutter release jacks;
a plurality of isolated switches, connected between the CPU and the output shutter release jacks; and
a USB IC, connected with the CPU; and
a DC input, supplying electricity to the isolated switches, the USB IC and the CPU;
a power source, providing the DC input; and
a computer, connected with the USB IC through a USB cable and capable of outputting a computer command to the CPU, wherein the CPU transforms the computer command into at least a control signal, so as to activate at least one of the isolated switches to form a single or multiple short signals, and the single or the multiple short signals are outputted through at least one of the output shutter release jacks, so as to individually, partially or together activate the cameras connected in parallel simultaneously.

6. The device for extending signals of a camera shutter release cable through isolated switches as claimed in claim 5, wherein the control board further comprises an input shutter release jack, a single short signal is capable of being inputted to the input shutter release jack and transmitted to and activating the isolated switches, so as to be extended into the multiple short signals, and the multiple short signals are outputted through the output shutter release jacks, so as to simultaneously activate all of the cameras connected in parallel.

7. The device for extending signals of a camera shutter release cable through isolated switches as claimed in claim 5, wherein the computer is a controller with another CPU, and the USB IC is an IEEE 1394 control IC or a RS232 control IC.

8. The device for extending signals of a camera shutter release cable through isolated switches as claimed in claim 5, wherein a number of the control board is plural, and each one of the control boards further comprises an ID control unit and an ID code in the ID control unit for differentiating the control boards connected in parallel with the computer through the USB cable.

9. The device for extending signals of a camera shutter release cable through isolated switches as claimed in claim 8, wherein the control boards are connected in parallel with the computer through USB cables directly or with a USB hub, and the computer outputs the computer command to at least one of the control boards selected through the ID code, so as to enable the CPU in the selected at least one of the control boards to transform the computer command into the at least a control signal for activating at least one of the isolated switches to form the single or the multiple short signals, and the single or the multiple short signals are outputted through at least one of the output shutter release jacks in the selected at least one of the control boards, so as to individually, partially or together activate the cameras connected with the selected control boards.
